(19) United States
(12) Patent Application Publication
(10) Pub. No.: US 2007/0246328 A1
(43) Pub. Date: Oct. 25, 2007

(54) High-Rate Space Efficient Article Singulator

(75) Inventor: Dan Reznik, Plainsboro, NJ (US)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS CORPORATE RESEARCH INC., PRINCETON, NJ (US)

(21) Appl. No.: 11/630,236

(22) PCT Filed: Jun. 21, 2005
(86) PCT No.: PCT/US05/21910

§ 371 Date: Dec. 20, 2006

Related U.S. Application Data
(60) Provisional application No. 60/581,547, filed on Jun. 21, 2004.

(51) Int. Cl. B65G 47/12

(52) U.S. Cl. 198/444

(57) ABSTRACT

An article merge unit (14) includes a first conveyor for conveying articles (24, 26) in a first stream having a first speed, a second conveyor (32, 34) having a plurality of lateral pushers (46), and a third conveyor (36). The first conveyor conveys the articles in the first stream to the second conveyors where the lateral pushers selectively diverting the articles across the second conveyor to the third conveyor. A control controls the conveying speed of the third conveyor and selectively actuates the lateral pushers to push a selected article from the first and second streams to the third conveyor wherein articles conveyed on the third conveyor are conveyed in a take-away stream having no side-by-side articles and the take-away stream has a greater speed than the first speed.

### TECHNICAL FIELD AND BACKGROUND OF THE INVENTION

The present invention relates to an article handling system and, more particularly, to a system that singulates articles into a single stream of articles for serial processing.

“Singulation” refers to the rearrangement of a disordered flow or stream of articles into one or more single-file output streams. One distinguishing feature of a singulated stream is the absence of side-by-side parcels. Further, consecutive articles are separated by a gap. Singulation is called for in applications where parcels originating from a bulk process need to undergo serial processing steps. Bulk processes include unloading, dumping, depalletizing, etc. Serial processing steps include bar code scanning, metering, weighing, labeling, diverting, etc. “Deshingling” refers to eliminating any mutual overlaps or stacking between parcels—for the purposes of this document, a bulk flow is assumed to be completely deshingled.

A key specification of singulators is their sustained processing rate (also known as throughput), which is measured in thousands of parcels per hour, or kpph. For example, some current commercial designs can deliver parcels at the rate of 7.5 kpph. Another specification is the singulator's footprint, i.e., how much floor space (and sometimes volume) the singulator occupies. For example, 15-by-5 meter² is a typical footprint for conventional singulators. A space-efficient singulator should have a large rate-by-footprint (rbf) ratio. A “high-rate” singulator is referred here as one capable of producing at least one output stream with at least 10 kpph.

More recently, as described in copending application entitled LOAD SINGULATION SYSTEM AND METHOD, Ser. No. 10/208,703, filed Jul. 29, 2002, a space-efficient singulator has been developed that conveys a bulk flow of articles on an array of load manipulation cells, which are independently controlled to move and process the articles into a continuous flow. The control is achieved using substantially modular manipulation hardware, which is driven by vision-based motion control algorithms. In addition, a space-efficient dual output conveyor has been developed that utilizes the above-noted space efficient singulator to output two streams of articles, which are then manipulated into a single stream by a conventional inductor.

These space efficient singulators have addressed some key deficiencies in the state-of-the-art singulator technology, which heretofore have consisted of “open-loop” devices, for which the articles' motion is governed by little or no sensing and offer low space- and power-efficiency. Open-loop singulators typically include a set of skewed rollers that pushes articles in a bulk flow stream towards a wall. The articles flush with the wall are released, but the side-by-side articles are extracted by an extraction belt and directed to a recirculation/buffering “pit”, onto which extracted parcels drop. These extracted articles are then conveyed and raised to the entrance of the singulator at which point they are reinserted into the incoming flow.

“Merging” refers to combining two streams of individual items onto one. A well-known example of merging occurs at the entrance of highways, where the incoming cars select opportune moments of entry based on the observed flow. Merging is important manipulation in materials handling when more than one singulated stream must be combined into one to be processed downstream by a single piece of hardware. This can arise both due to economic or throughput issues. Economic issues arise when machinery is not available to process more than one stream. Throughput issues refer to a scenario where the output of a materials handling process must be above a certain number of items per unit of time. For example, a sortation facility required to deliver 12000 parcels per hour will need to merge two or more streams to produce the required levels of output throughput. When designing modern materials handling technology, consideration is typically given to cost, noise, safety, and the size of the system.

Current merge systems are mostly based on a highway-entrance metaphor. Items are told to wait until opportune entry events are recognized. Alternatively, the input flows to be merged must be slowed down until entry events are recognized. For example, the speed of articles to be merged may be controlled by a series of belts positioned prior to their entrance into the main flow. The articles are inducted into the flow at opportune moments where they will not collide and/or interfere with parcels already on the merged flow. In other systems, such as “high-rate” induct systems described in U.S. Pat. Nos. 6,715,598 and 6,513,641, the merging operation is passive but the speed at which articles are delivered is controlled by software over a sequence of variable speed controllers.

### SUMMARY

Accordingly, the present invention provides a method and apparatus for handling and manipulating a disorganized flow of articles so that they are transformed into an ordered flow of articles suitable for serial processing in a manner that requires less space and potentially requires fewer components and consumes less energy than heretofore known.

In one form of the invention, an article merge unit includes a first conveyor for conveying articles in a first stream having a first speed, a second conveyor with a plurality of lateral pushers, and a third conveyor. The first conveyor conveys the articles in the first stream to the second conveyor. The lateral pushers selectively divert the articles across the second conveyor to the third conveyor. In addition, the merge unit includes a control that controls the conveying speed of the third conveyor and selective actuation of the lateral pushers to push a selected article from the first stream to the third conveyor wherein articles conveyed on the third conveyor are conveyed in a take-away stream having no side-by-side articles and the take-away stream has a greater speed than the speed of the first conveyor.

In one aspect, the merge unit also includes a fourth conveyor with a plurality of lateral pushers and a fifth conveyor for conveying a second plurality of articles in a second stream with a second speed. The fifth conveyor conveys the second plurality of articles to the fourth conveyor, and the control controls the lateral pushers of the fourth conveyor to selectively push articles in the second stream onto the third conveyor wherein the first plurality of articles and the second plurality of articles are inducted onto the third conveyor such that the third conveyor conveys the articles in a take-away stream with no side-by-side articles and the take-away stream has a greater speed than the speeds of either the first or fifth conveyor. For example, the take-away speed may be at least twice the speed of the first or fifth conveyor.

In further aspects, the second conveyor comprises a slat conveyor with the plurality of lateral pushers. For example, the lateral pushers may comprise shoe sorters.

In yet a further aspect, the merge unit is combined with a dual-output singulator, with the dual-output singulator conveying two singulation stream of articles to the merge unit. One of the streams is conveyed to the first conveyor. The other stream is conveyed to the fifth conveyor. For example, the dual-output singulator includes a singulator bed. In addition, the singulator may include a diverter, such as a steering wheel diverter, and a conveyor junction, such as a roller junction. The singulator bed conveys one or more articles to the diverter, which conveys one or more articles to the junction. The junction conveys articles in the first stream and second stream for input into the first and fifth conveyors, respectively.

In another aspect, the singulator may be combined with a conveyor that generally directs articles away from the middle of the conveyor, such as a herringbone conveyor, to widen the flow of the articles, which conveys articles in a bulk flow to the singulator.

According to yet other aspects, the singulator bed has a bed width. The second, third, and fourth conveyors are in a side-by-side relationship and have a merge unit width spanning the second, third, and fourth conveyors. The bed width is optionally approximately equal to the merge unit width.

In yet other aspect, the control actuates a plurality of the lateral pushers to push the selected articles to the third conveyor. For example, the control may actuate a plurality of contiguous pushers to push the selected article onto the third conveyor.

According to yet another aspect, the second conveyor comprises a plurality of slats and a plurality of shoes, with the shoes providing the lateral pushers. For example, each of the shoes may mount between a pair of slats or to a respective slat of the plurality of slats.

In another form, an article handling system includes a first input, a second input, a take-away conveyor, a first conveyor with a plurality of lateral pushers, and a second conveyor with a plurality of lateral pushers. The first input conveys a first plurality of articles in a first stream to the first conveyor. The second input conveys a second plurality of articles in a second stream to the second conveyor. In addition, the system includes a control, which controls the lateral pushers and the conveying speed of the take-away conveyor wherein articles diverted to the take-away conveyor by the pushers are conveyed by the take-away conveyor in a stream with no side-by-side articles and at a speed greater than the speed of either of the first or second streams.

In one aspect, the first input comprises the output of a singulator. Optionally, the system may include, for example, a herringbone conveyor, which conveys articles to the singulator.

In another form of the invention, a method of singulating includes providing a first conveyor, conveying a plurality of articles in a first stream to the first conveyor with a first conveying speed, providing a second conveyor, selectively pushing one of the articles onto the second conveyor from the first conveyor, and conveying the pushed article on the second conveyor with a conveying speed greater than the conveying speed of the first conveyor.

In another aspect, the method also includes providing a third conveyor, conveying a second plurality of articles in a second stream to the third conveyor at a third conveying speed, and selectively pushing one of the articles in the second stream onto the second conveyor.

In a further aspect, a disorganized flow of articles is singulated into the first plurality of articles in the first stream and the second plurality of articles in the second stream.

In yet another aspect, the articles are selectively pushed by at least one pusher. Optionally, the articles are selectively pushed by pushing a plurality of pushers and, further, by a plurality of contiguous pushers.

Accordingly, the article handling system of the present invention provides a more efficient system that can achieve higher processing rates and in a smaller space than heretofore known, and further with fewer devices, which may also reduce the cost of the system.

These and other objects, advantages, purposes, and features of the invention will become more apparent from the study of the following description taken in conjunction with the drawings.

### DESCRIPTION OF THE DRAWINGS

FIG. 1 is a plan view of the article handling system of the present invention;

FIG. 2 is a perspective view of the singulator of the article handling system of FIG. 1;

FIG. 3 is a schematic plan view of the singulator of FIG. 2;

FIG. 4 is a schematic of the control system and singulator of FIGS. 1-3;

FIG. 5 is a schematic plan view of the merge unit of the article handling system of FIG. 1;

FIG. 6 is a perspective view of the merge unit of FIG. 5;

FIG. 7 is an enlarged view of one of the conveyors of the merge unit of FIG. 6;

FIG. 8 is a schematic view of the merge unit of the present invention in combination with a simplified singulator;

FIG. 9 is another embodiment of a simplified singulator in combination with the merge unit;

FIG. 10 is a second embodiment of the merge unit of the present invention in combination with a simplified singulator;

FIG. 11 is a third embodiment of the merge unit of the present invention in combination with a pair of singulators;

FIG. 12 is an algorithm merge for the merge motion controller for a merge unit of the present invention;

FIG. 13 is a plan view of the merge unit illustrating a sequence of articles being merge onto a take-away conveyor;

FIG. 14 is a plan view of an alternate method of merging articles in the merge unit onto the take-away conveyor; and

FIG. 15 is a plan view of the merge unit illustrating the geometric parameters used in controlling the merge of the article on the merge unit.

### DETAILED DESCRIPTION OF THE PREFERRED EMBODIMENTS

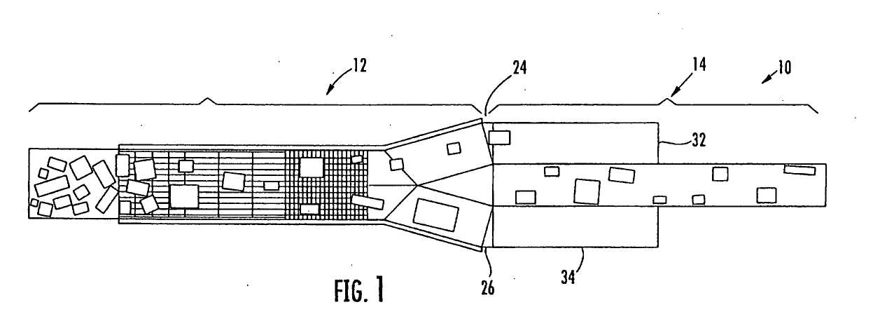

Referring to FIG. 1, the numeral 10 generally designates an article handling system of the present invention. As will be more fully described below, article handling system 10 provides a system and method that is capable of a high-rate, space efficient article dual-output singulation and subsequent induction of the two streams of singulated articles into a single flow that is free of side-by-side articles, i.e., without overlaps perpendicular to the flow direction. Each stream is thought of as singulated when the articles flow one by one, with a clear, non-zero gap separating all adjacent articles.

In the illustrated embodiment, system 10 includes at least two devices—namely a singulator 12, which is configured and arranged to take a bulk flow (namely a flow of articles in a disordered stream) and output the articles as two singulated flows of articles, and a merge unit 14, which then inducts the two flows or streams of articles into a single flow of articles with no side-by-side articles for later serial processing, such as scanning, labeling, metering, weighing, diverting, sorting or the like. As will be appreciated from the following description, system 10 is capable of providing a high sustained processing rate (also known as throughput) and, further, occupies less floor space, and potentially less volume, than conventional singulating and induct systems, which can reduce the number of components and, hence, the cost. For example, it has been found that the present invention is capable of producing a throughput of 12 kpph or more.

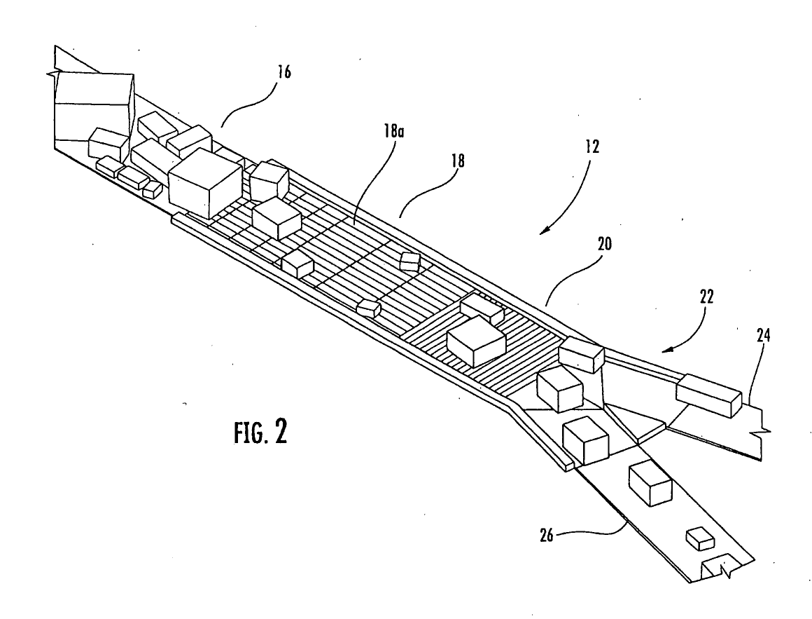

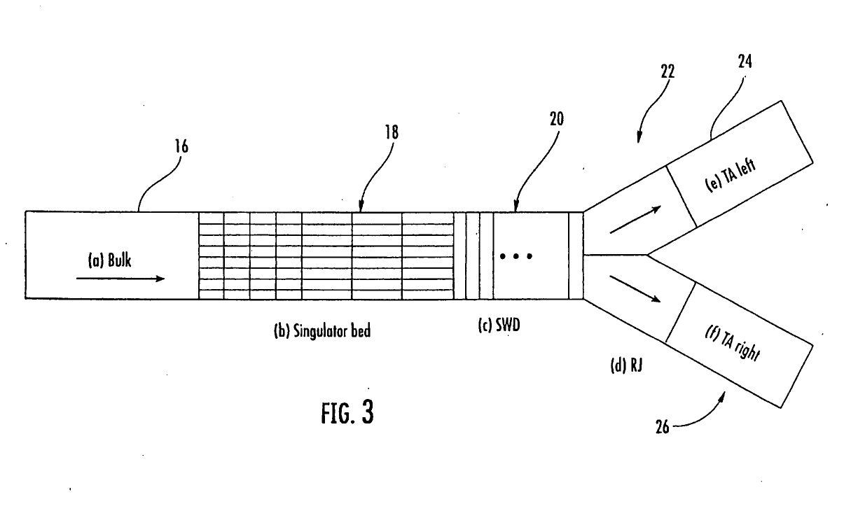

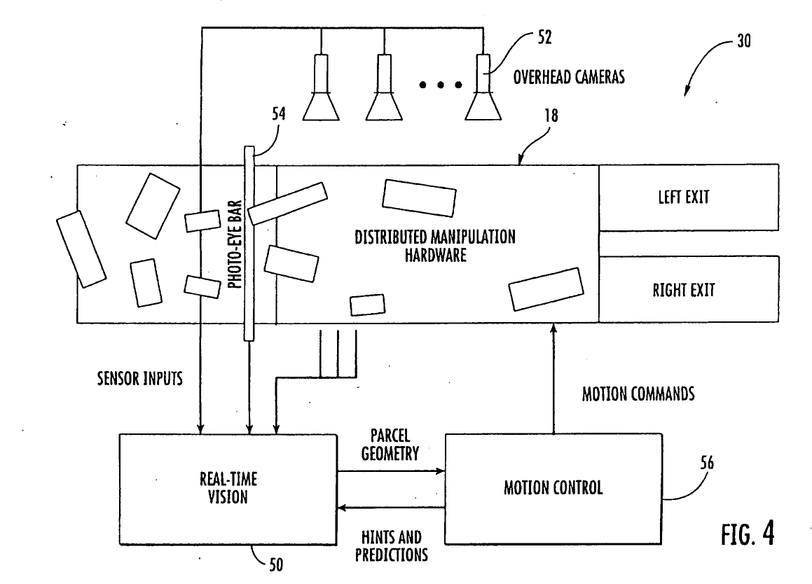

Referring to FIG. 2, singulator 12 receives articles from a bulk conveyor 16 and includes a singulator bed 18 and a diverter 20, such as a steering wheel diverter, which directs articles to a conveyor junction 22, such as a roller junction. Junction 22 feeds the singulated flows of articles that are output from singulator bed 18 and diverter 20 to take-away conveyors 24 and 26 for processing by merge unit 14, described below. Suitable steering wheel diverters are described in U.S. Pat. No. 5,588,519 and copending application Ser. No. 10/710,824, which are incorporated by reference in their entireties. Singulator 12 is controlled by a control system 30 (FIG. 4), which manipulates the articles conveyed across the singulator based on a substantially modular manipulation hardware driven by vision-based motion control algorithms, which are described in commonly owned copending application entitled LOAD SINGULATION SYSTEM AND METHOD, Ser. No. 10/208,703, filed Jul. 29, 2002, which is incorporated by reference in its entirety herein. The principal operation of singulator 12 is to extract the articles as they flow over an array of manipulation cells, such as conveyor belts 18a, of singulator bed 18, which are preferably each with an independently controllable speed. The singulator bed 18 directs the articles to the diverter 20, which provides lateral diverts for the articles and directs the articles to the junction, which in turn directs the articles in a dual output singulated flow, as noted above. For further details of control system 30, reference is made to the above-referenced copending application.

Referring again to FIG. 1, take-away conveyors 24 and 26 are aligned with and direct articles to merge unit 14. Merge unit 14 is configured and arranged to manipulate the two singulated flows of articles into a single flow of articles that has a greater speed than either speeds of the incoming singulated flows from conveyor 24 or 26, as will be more fully described below.

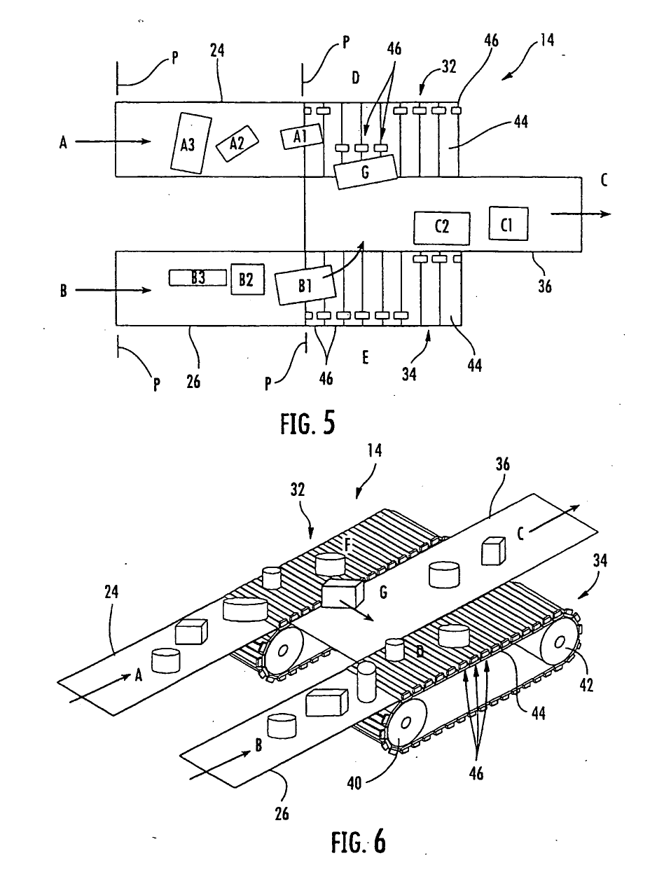

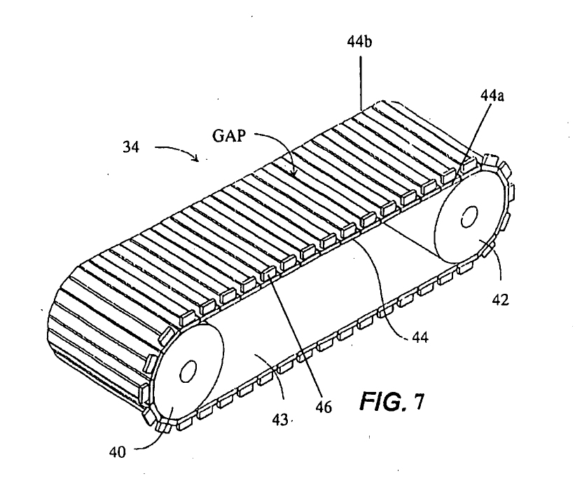

Referring to FIGS. 5 and 6, merge unit 14 includes a first conveyor 32 and a second conveyor 34, which provide lateral diverts of the respective articles onto a central or take-away conveyor 36. In the illustrated embodiment, conveyors 32 and 34 comprise slat conveyors, which are equipped with lateral pushers, such as shoe sorters, for diverting the articles across the respective conveying surfaces of conveyors 32 and 34 onto conveyor 36. Suitable shoe sorters include the sorters described in commonly assigned U.S. Pat. Nos. 4,738,347; 5,127,510, 5,165,515; and 6,041,909 and 5,927,465, which are all hereby incorporated herein by reference in their entireties. Other examples are described in U.S. Pat. Nos. 3,361,247; 5,409,095; and 4,884,677; and European Published Patent Applications EP 0 602 694 B1 and EP 0 444 734 A1, which are also incorporated by reference in their entireties herein.

The diverts by the lateral pushers and the speed of take-away conveyor 36 is controlled by controller 30 using a sensor based algorithm, such as the algorithm disclosed in copending application Ser. No. 10/208,703, filed Jul. 29, 2002, now published under U.S. Pub. No. US 2003/0141165 A1 on Jul. 31, 2003, or the algorithm described below. The principal operation of the algorithm is to push entering articles towards the middle of conveyor 36 when no blocking parcel is found on the corresponding portion of conveyor 36. A push is essentially a lateral divert that is accomplished by a quick translation of one or more pushers, such as shoe sorters. Optionally a contiguous set or a spaced set of shoes that span the pushed article's length may be used to push the article.

Conveyor 36 is operated to run faster than the conveying speeds of conveyors 24 and 26, which provide inputs to merge unit 14, so that pushed articles quickly overtake any incoming articles thereby freeing space for any subsequent pushes. Consequently, merge unit 14 achieves efficient and reliable operation using a fraction of the footprint of a conventional induction unit. In addition, by combining singulator 12 with merge unit 14, system 10 achieves high sustained processing rates, for example, typically about 12 kpph and up to about 15 kpph and, further, as previously noted, occupies a reduced footprint, for example 15 meters (m)×16 meters (m) (90 m²). Consequently, the rbf ratio of 12 kpph at a footprint of 6 m×1.6 m (9.6 m²) equates to an rbf of 1.25 as compared to commercially available units that can achieve up to 15 kpph but with a footprint of 15 m×16 m (90 m²), which equates to an rbf of 0.16. Therefore, as can be appreciated, the present invention may increase the rbf 7½ fold over a conventional unit. System 10 achieves these processing rates and ratios while still providing collision free or gentle parcel handling, with low power consumption and the desired reliability and, further, programmability.

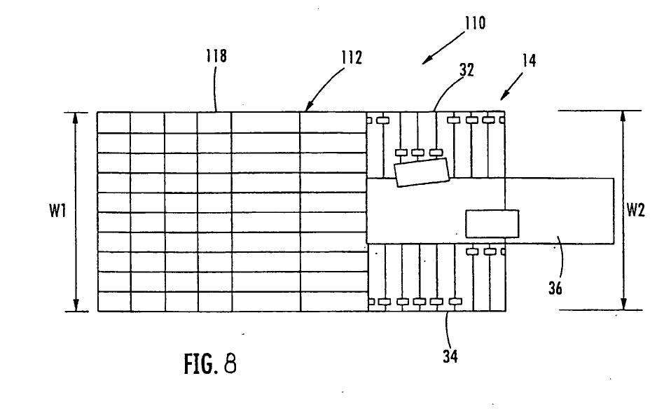

Referring to FIG. 7, each conveyor 32, 34 includes two rollers 40 and 42 and a slat belt with plurality of slats 44, with each slat 44 associated with at least one independent pusher 46, which can be triggered to move from one end 44a of the slat 44 to an opposed end 44b of the slat 44 at a desired speed and moment. However, as noted, the pushers may be guided between the slats—hence, each slat may be associated with two pushers. Pushers 46 may be driven by servo motors or pneumatics. For a suitable lateral translation conveyor that may be used for conveyors 32, 34, reference is made to commonly owned U.S. Pat. No. 6,698,571, which is incorporated by reference in its entirety. As described in the referenced patent, each pusher or shoe glides on the gaps between the adjacent slats. Another suitable shoe is disclosed in commonly U.S. Pat. No. 5,127,510, which is also incorporated by reference in its entirety herein. The shoes in the '510 patent extend around the slats rather than simply between the slats. When adjacent groups of such pushers are acted upon in tandem, multiple-slat width packages can be diverted orthogonally from the direction of flow.

Referring again to FIG. 5, input conveyors 24 and 26 are operating typically at a fixed speed and typically the same speed. However, it should be understood that the speeds of conveyors 24 and 26 may be variable and controlled by control system 30. Conveyor 36, in contrast, is preferably running at a greater speed than the speeds of input conveyors 24 and 26 and of conveyors 32, 34 and, optionally, two or more times the speed of conveyors 32 and 34. Conveyors 32 and 34 generally have the same conveying speed as conveyors 24 and 26, respectively; however, as will be more fully described below in some applications, conveyors 32 and 34 may have greater conveying speeds that the conveying speeds of the inputs to merge unit 14. Consequently, the speed of the articles can be increased two to four fold or more over the input conveying speed.

Pushers 46 are controlled to laterally divert articles onto conveyor 36 at specific times and optionally at constant divert speeds. However, it can be appreciated that the speed of each pusher may be individually controlled and, further, may be variable. Similarly, as noted the conveying speeds of conveyors 32 and 34 may be similarly controlled so that their respective speeds may be increased over the conveying speeds of input conveyors 26 and 24.

In the illustrated embodiment, the articles are pushed by a plurality of pushers and, further, by a plurality of contiguous pushers that span the length of the respective article. Further, the pushers are typically actuated so they push in unison or in line to provide a parallel divert for the respective article. However, it should be understood that two spaced pushers may be used to push the article, preferably with pushers that are spaced so that they substantially span the length of the article—in other words with one at each end of the article. While spaced pushers would preferably be moved in unison, they can be moved independently and further with different speeds and also at different times should greater rotation of the article be desired. The principle of operation is to push entering articles towards the takeaway conveyor or middle conveyor when no “blocking” parcel is found on the takeaway conveyor. A “push” (essentially a lateral divert) is accomplished by the quick translation of one or more pushers. As noted, the conveyor belt runs faster than the inputs and conveyors 32, 34, causing pushed articles to quickly overtake any incoming ones, freeing space for any subsequent pushes. The merge unit achieves reliable operation at a fraction of the footprint of conventional induct-based designs.

As best seen in FIG. 5, this parallel divert pushing action is likely to provide some rotation when a rectangular article is not aligned in the direction of flow so that the item will more align with the flow direction of conveyor 36 as indicated by the arrow. An item, for example B1, entering conveyor 34 from conveyor 26 may have a curved path corresponding to its planned divert onto the stream. As noted, the speed of conveyor 36 may be variable and adjusted by software to create desired gaps between the respective articles diverted onto the conveyor.

As noted above, conveyors 32 and 34 may comprise lateral translation conveyors, such as illustrated in FIG. 6 and described above in reference to FIG. 7. However, it should be understood that other lateral translation units, such as cross-belt sorters or the like, may be used to laterally transfer the articles onto conveyor 36.

Optionally, to facilitate the singulation of the two streams of articles, as noted conveyors 32 and 34 may be operated at a speed greater than the speed of the input conveyors 24 and 26. For example, the speed of conveyors 32 and 34 may be up to two to three times faster than the speed of input conveyors 24 and 26. In this manner, the articles are properly gapped for further processing.

Referring to FIG. 8, the numeral 110 generally designates another embodiment of the article handling system of the present invention. In this embodiment, merge unit 14 is combined with a simplified singulator consisting of a singulator bed 118, which is similar to singulator bed 18 and which simultaneously singulates parcels flowing in the left and right area of the device. In the illustrated embodiment, singulator bed 118 conveys the articles to the respective conveyors 32 and 34 of merge unit 14 and therefore, provide two inputs to merge unit 14. In order to properly mate the singulator with the merge unit 14, the bed width W1 of singulator bed 118 is approximately equal to the overall merge width W2 of merge unit 14, which spans the width of conveyors 32, 34, and 36, which are positioned in a side-by-side arrangement. To avoid rotation at merge unit 14, parcels intersecting lines L1 or L2 should be diverted without rotation. For example, the conveying speed of take-away conveyor 36 may be slowed down, for example to the speed of conveyors 32 or 34.

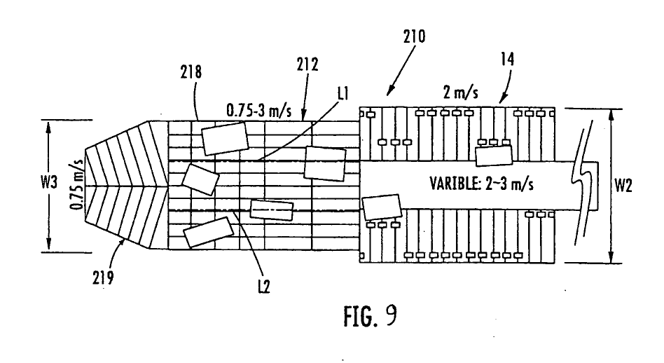

Referring to FIG. 9, the numeral 210 designates another embodiment of the article handling system of the present invention in which the merge unit 14 is combined with a singulator 212 that has a bed width W3 which is less than the overall merge unit width W2. In addition, system 210 incorporates a conveyor 219 that directs the articles away from the middle of the conveyor, such as a herringbone conveyor, which is used to widen the parcel flow at the input to singulator bed 218 of singulator 212. An example of a herringbone conveyor that moves articles inwardly toward the middle of the conveyor is disclosed in U.S. Pat. No. 6,401,936, which is also incorporated by reference in its entirety herein. It should be understood that by reorienting the rollers of the herringbone will result in the flow of the articles being widened rather than narrowed as in the case of the herringbone conveyor disclosed in the referenced patent.

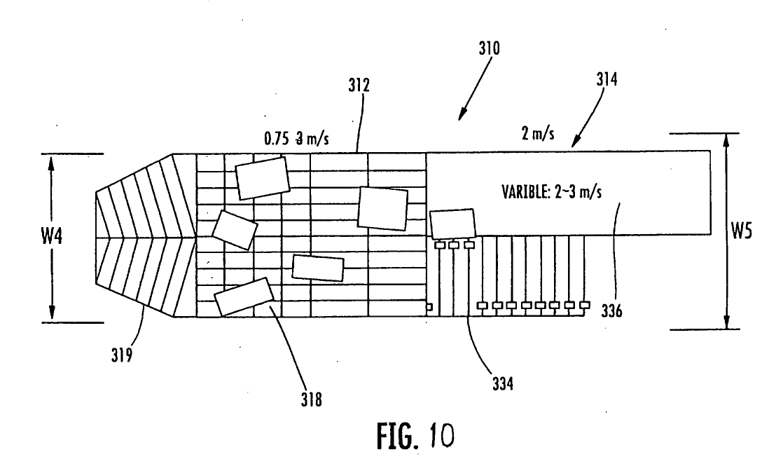

Referring to FIG. 10, the numeral 310 designates another embodiment of the article handling system of the present invention. Article handling system 310 includes a modified merge unit 314 in combination with a singulator 312, similar to singulator 212, and a conveyor 319 that widens the flow of the articles, such as a herringbone conveyor. In this application, the bed width W4 of the singulator bed 318 of singultor 312 is commensurate in size with the merge unit width W5. In the illustrated embodiment, merge unit 314 comprises a single-sided merge unit that consists of a first conveyor 334, which provides the lateral push to the respective articles conveyed to merge unit 314 from singulator 312, and a take-away conveyor 336. In this manner, merge unit 314 may be more cost effective. Although illustrated with a conveyor 319 that widens the flow of the articles, it should be understood that conveyor 319 is optional, given the commensurate widths of the singulator and the merge unit.

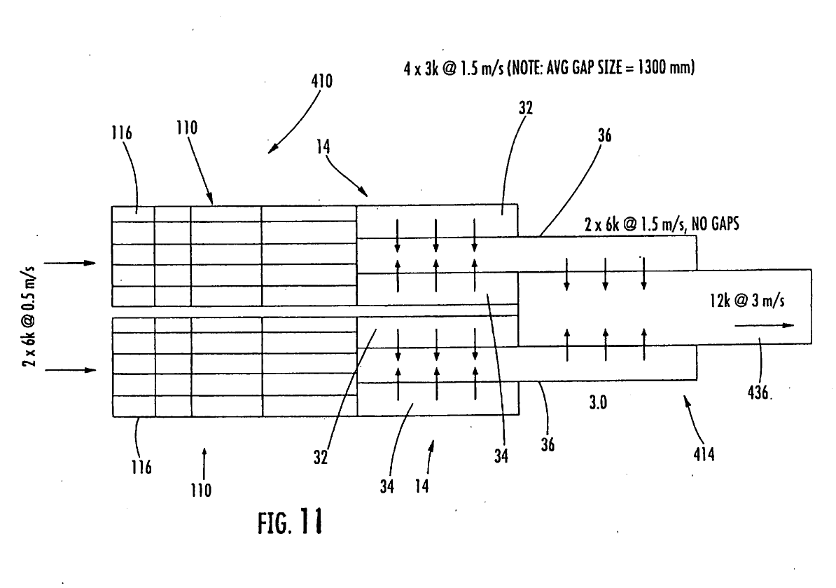

Referring to FIG. 11, the numeral 410 designates another embodiment of the article handling system of the present invention. Article handling system 410 is configured and arranged to provide a cascading arrangement in which two singulator/merge units are combined with an additional merge unit such that the output rate becomes the sum of all output streams—in other words four-way parallelism. As would be understood by those skilled in the art, this principal can be extended to achieve higher output rates, though this may be limited by equipment cost and achievable conveying speeds.

As best seen in FIG. 11, system 410 combines two article handling systems, such as article handling system 110. The output of the respective take-away conveyors 36 of each system 110 provides input to a third merge unit 414, which can effectively double the output of each of the outputs of the article handling systems 110 to achieve a high output rate. For example, the initial conveying speed on singulators 116 may be doubled by the respective merge units 14, which in turn has an output speed that may be doubled by merge unit 414. For example, the conveying speed of singulators 116 may be set at approximately 0.5 meters per second where the output of the merge units having conveying speeds of 1.5 meters per second, which is then increased to 3 meters per second by merge unit 414. Optionally, the conveying speeds of conveyors 32 and 34 of the respective merge units 14 may be increased over the incoming speed of the articles into the merge unit, which forms a gap between the respective articles. Takeaway conveyor 36 may optionally have a similar conveying speed to conveyors 32 and 34 such that the gaps are essentially eliminated between the respective articles conveyed on takeaway conveyors 36. Merge unit 414 may then laterally push the articles onto takeaway conveyor 436 at a speed that is double the speed of the takeaway conveyors 36, which provide input into merge unit 414.

Referring to FIG. 4, control 30 includes a vision system 50 and a controller 56. Vision system 50 includes one or more cameras 52, such a digital cameras, for scanning articles as the are conveyed over the singulator bed, and one or more detectors 54, such as a photo-eye bar or array which are used to signal when an article enters the singulation bed. Vision system 50 collects real-time geometric information about the articles being conveyed and conveys that information to controller 56, which is programmed with the appropriate algorithms referenced above to issue motion control commands to the conveyor belts or manipulation cells of the singulator. As described in the referenced application, the singulator bed may include a matrix of manipulation cells each with an upper surface, which form a load manipulation surface. The upper surfaces are configured for supporting articles and horizontally vibrating to transfer the article from the upper surface of one cell to the upper surface of one or more adjacent cells. Each cell includes one or more actuators configured to move the upper surface to thereby move the articles in a desired direction. The number and size of the cells may vary depending on the application and size and type of articles the system is configured to singulate. Further, the array may have a non-rectangular contour. As described, an incoming stream of articles is dynamically rearranged into single-file exiting streams by speeding up the article nearest to the exit with respect to other incoming loads.

As noted previously, the motion control of the respective conveyor speeds and positions of the various moveable components of the present invention relies on partial geometry and information reported periodically by a real time vision module. For details of the suitable algorithms and motion control, reference is made to copending application Ser. No. 10/208,703, filed Jul. 29, 2002, entitled LOAD SINGULATION SYSTEM AND METHOD, which is assigned to Siemens Corporation.

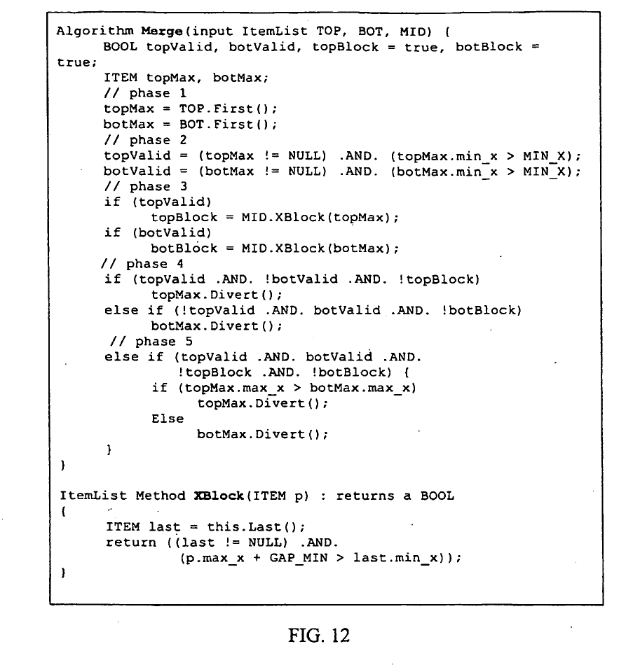

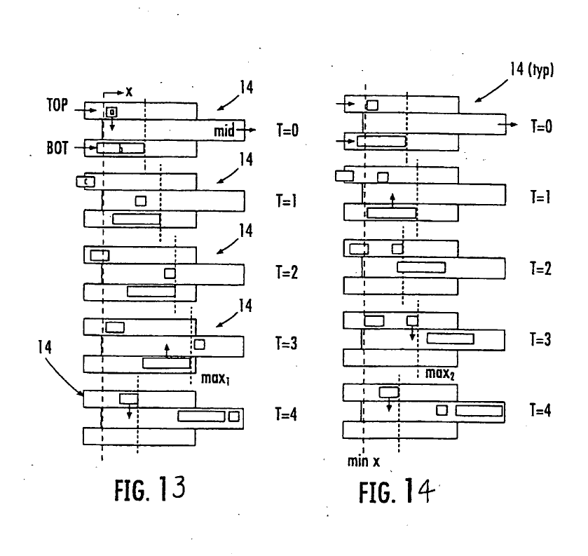

Referring to FIG. 12, a basic version of another motion control algorithm for the merge units is shown in pseudo-code. The basic goal of the algorithm in FIG. 12 is to insert parcels which enter either slat conveyor completely only at moments where there isn't a “blocking” parcel on the middle takeaway (see X block function). Such opportune moments are guaranteed to exist since the mid takeaway flows at twice the speed of either slat conveyor, allowing for blocking articles to overtake the lateral ones over a period of time inversely proportional to the speed ratios and related to the articles' relative lengths.

The algorithm consists of a main portion (called “merge”) called at every iteration of the motion controller system (e.g., as fast as practical, typically every 10 s or milliseconds). This algorithm presupposes the caller to provide it with three lists of items (without loss of generality, items are rectangular parcels). These lists are TOP, BOT, and MID, corresponding to sets of singulated articles currently on A+D, B+E, and C regions of merge unit 14 (FIG. 6). Building these three lists is derived from sensors such as photo eyes P positioned at the entrance of A and B (and D and E) or tracking of articles, e.g., by overhead video cameras in combination with image processing software. The three lists are passed to merge with the items sorted in descending order of maximum x value, i.e., from right to left as seen in FIG. 6. In that figure, TOP={G, A1, A2, A3}, BOT={B1, B2, B3}, and MID={C2, C1}. Note: parcel G will be removed from TOP and placed at the end of MID as soon as it is diverted. Merge makes use of one global constant, MIN_X, which denotes the origin of the system, i.e., the left most x-coordinate of the takeaway conveyor 36, C. By convention, one could set MIN_X=0.

In phase 1, topMax and botMax are extracted from the head of each corresponding list (recall these are pre-sorted by item's maximum x value, so the element at the head of each list will be the left most member). In the p-code, list method First( ) returns the head of a list or NULL if the list contains no members.

In phase 2, boolean values topValid and botValid are computed which determine if both the corresponding list had a head and if that item's minimum X value was past the entrance of the takeaway conveyor (denoted by MIN_X, see above).

In phase 3, Merge determines if a valid topMax (resp. botMax) is blocked by a parcel currently flowing through the middle. Blocking, computed by the list method XBlock, shown at the bottom of the inset, makes use of a global constant, GAP_MIN which is the fixed gaps to allow between outgoing packages. The comparison done by XBlock is as follows: if the maximum x of a given item added to GAP_MIN overlaps with the last item on the mid item (i.e., the sum is larger than the last item's minimum x), than XBlock determines that the last item in MID does block the item in question, otherwise, there's no block.

Phase 4 acts as following: if topMax (resp. botMax) is not blocked, than the Divert( ) method is called. This method presupposes that the narrowest adjacent set of lateral pushers (or shoes, or other divert embodiment) is activated causing a fast-as-practical motion of that item towards the center or take-away conveyor. The divert must occur at the current position of the item.

Phase 5 attempts to resolve a “tying” issue, i.e., when both topMax and botMax are unblocked. It resolves the issue by simply diverting the rightmost object.

Besides executing correct merging, the motion control optionally ensures that the maximum unmerged wavefront is minimized (this shortens the slat conveyor length). As would be understood from FIG. 12, the algorithm is greedy (see FIG. 13)—it chooses to merge the rightmost unblocked item. While this saves CPU time, a situation where this leads to a poor choice is shown in FIG. 13, where five evenly-spaced snapshots of merge unit 14 are illustrated showing the current strategy from top to bottom. Let K denote the ratio of takeaway speed to induct speed, with K typically >=2. The greedy strategy merges item A unblocked first, proceeding to merge item B once it becomes unblocked by A. This causes the unmerged wavefront—max₁—to reach nearly the end of the BOT conveyor.

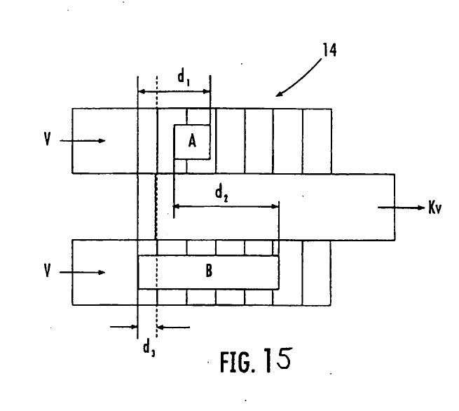

A second “optimized” strategy is illustrated from top-to-bottom in the merge units 14 illustrated in FIG. 15. The control opts to wait out on A and merge B first (once it is completely on the slat conveyor). At T=3, A can be merged as it is no longer blocked by B. Under this strategy the maximum wavefront here—max₂—is significantly less than max₁. The choice between the “greedy” or an optimized merge is defined by geometric parameters illustrated in FIG. 15 relative to merge unit 14. For example, let A be a short item which is completely contained in the TOP lateral divert, and let B be a longer item partially contained by the BOT lateral divert. Assume the two intakes are at constant speed v, and the takeaway moves at Kv, with K>1 (typ. 2).

The quantities are defined as follows:
d₁=Aₘₐₓ−Bₘᵢₙ
d₂=Bₘₐₓ−Aₘᵢₙ
d₃=Xₘᵢₙ−Bₘᵢₙ

The maximum wavefronts can then be computed as:

$${max}_{1} = MAX ( {A}_{max} , {B}_{max} + \frac{{d}_{2}}{K - 1} )$$

$${max}_{2} = MAX ( {B}_{max} , {A}_{max} + \frac{{d}_{1}}{K - 1} ) + {d}_{3}$$

The optimized strategy is picked when max₂<max₁, otherwise the greedy strategy is picked. It should be understood that optimization can be extended to choose an optimal merging order involving more than two incoming items. This strategy involves predicting the maximum wavefront for a particular merge sequence and choosing the sequence which yields the minimum max wavefront. In this approach it is assumed that the merge time and intra item parcels are negligible. However, these parameters can be added as extra distances to the model.

The takeaway conveyor speed can be controlled so as to adapt for starvation and/or create any desired gap between a given pair of adjacent articles, e.g., as their heights are discovered by image processing. In an application where the merge is used as a postprocessing stage to parallel singulation as described above, this allows for the singulator to impose near-zero gaps during singulation (thus increasing the throughput, or equivalently, shortening the device required for a given throughput).

As described above, this merge technology can be used for combining the output flows of one or more singulators. The end result from this merge technology is that two or more singulated streams can be combined into one with roughly at least twice the throughput.

Accordingly, the present invention provides a system for efficiently singulating a bulk flow and then merging the singulated streams while addressing and overcoming many of the limitations of the prior art systems. Moreover, because functionality is achieved under flexible, geometric- and sensor-based software control, the current design provides for a number of other benefits, such as automatic orientation correction, flexible output gap control, flexible output bandwidth control, non-recirculation of unmerged parcels (continuous flow), etc. On a reduced footprint, the present system provides for singulating a bulk flow of articles into two or more singulated streams that are input in a merge unit to be merged onto one output singulated stream with increased throughput. Gaps on the output stream are controllable online, and the operation results in better justification of rectangular boxes with the output direction. The present invention may be used for the handling of a wide range of articles or items, such as parcels, wafers, flats, which are organized in streams in some material handling application.

While several forms of the invention have been shown and described, other forms will now be apparent to those skilled in the art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. An article merge unit comprising:
a first conveyor conveying articles in a first stream having a first speed;
a second conveyor having a plurality of lateral pushers, said first conveyor for conveying the articles in the first stream to said second conveyor;
a third conveyor, said lateral pushers selectively diverting the articles across the second conveyor to said third conveyor, and said third conveyor having a conveying speed; and
a control, said control controlling said conveying speed of said third conveyor and selective actuation of said lateral pushers to push a selected article from said first stream to said third conveyor wherein articles conveyed on said third conveyor are conveyed in a take-away stream having no side-by-side articles and said take-away stream has a greater speed than said first speed.

2. The article merge unit according to claim 1, further comprising a fourth conveyor with a plurality of lateral pushers and a fifth conveyor for conveying a second plurality of articles in a second stream with a second speed, said fifth conveyor conveying the second plurality of articles to said fourth conveyor, said control controlling said lateral pushers of said fourth conveyor to selectively push the second plurality of articles onto said third conveyor wherein the first plurality of articles and the second plurality of articles are inducted onto said third conveyor such that said third conveyor conveys the articles in a take-away stream with no side-by-side articles and said take-away stream has a greater speed than said first speed or said second speed.

3. The article merge unit according to claim 2, wherein said take-away speed is at least twice the speed of said first or second speed.

4. The article merge unit according to claim 1, wherein said second conveyor comprises a slat conveyor with said plurality of lateral pushers.

5. The article merge unit according to claim 3, wherein said lateral pushers comprise shoe sorters.

6. The article merge unit according to claim 2, further in combination with a dual-output singulator, said dual-output singulator conveying two singulation stream of articles to said merge unit, a first stream of said streams being conveyed to said first conveyor, a second stream of said streams being conveyed to said fifth conveyor.

7. The article merge unit according to claim 6, wherein said dual-output singulator includes a singulator bed.

8. The article merge unit according to claim 7, wherein said singulator further includes a diverter and a conveyor junction, said singulator bed conveying one or more articles to said diverter, said diverter conveying one or more articles to said junction, and said junction conveying articles in said first stream and said second stream for input into said first and fifth conveyors, respectively.

9. The article merge unit according to claim 7, further comprising a widening conveyor that is configured to widen the flow of the articles and conveying the articles in a bulk flow to said singulator.

10. The article merge unit according to claim 7, wherein said singulator bed has a bed width, said second, third, and fourth conveyors being in a side-by-side relationship having a merge unit width spanning said second, third, and fourth conveyors, and said bed width being approximately equal to said merge unit width.

11. The article singulator according to claim 1, wherein said control actuates a plurality of said lateral pushers to push the selected articles to said third conveyor.

12. The article singulator according to claim 11, wherein said control actuates a plurality of contiguous pushers to push the selected article onto said third conveyor.

13. The article singulator according to claim 1, wherein said third conveyor comprises a belt conveyor.

14. The article singulator according to claim 1, wherein said second conveyor comprises a plurality of slats and a plurality of shoes, said shoes comprising said lateral pusher.

15. The article singulator according to claim 14, wherein each of said shoes is mounted to a respective slat of said plurality of slats.

16. An article handling system comprising:
a first input;
a second input;
a take-away conveyor having a conveying speed;
a first conveyor with a plurality of lateral pushers, said first input conveying a first plurality of articles in a stream to said first conveyor;
a second conveyor with a plurality of lateral pushers, said second input conveying a second plurality of articles in a stream to said second conveyor; and
a control, said control controlling said lateral pushers and said conveying speed of said take-away conveyor wherein articles diverted to said take-away conveyor by said pushers are conveyed by said take-away conveyor in a stream with no side-by-side articles and at a speed greater than the speed of either of said first or second streams.

17. The article handling system according to claim 16, wherein said first input comprises a singulator.

18. The article handling system according to claim 16, further comprising a widening conveyor that is adapted to widen the flow of the articles, said widening conveyor conveying the articles to said singulator.

19. The article handling system according to claim 17, wherein said singulator has a bed width, said second, third, and fourth conveyors are arranged in an adjacent relationship having a merge unit width, said bed width being approximately equal to said merge unit width.

20. The article handling system according to claim 19, wherein said first and second inputs comprise a dual-output from a singulator.

21. A method of singulating comprising:
providing a first conveyor;
conveying a plurality of articles in a first stream to the first conveyor with a first conveying speed;
providing a second conveyor;
selectively pushing one of the articles onto the second conveyor from the first conveyor; and
conveying the pushed article on the second conveyor with a second conveying speed greater than the first conveying speed.

22. The method of singulating according to claim 21, further comprising providing a third conveyor;
conveying a second plurality of articles in a second stream to the third conveyor at a third conveying speed;
said selectively pushing includes selectively pushing one of the articles from the first stream and the second stream onto the second conveyor; and
said conveying the pushed articles on the second conveyor comprises conveying the pushed articles on the second conveyor with a second conveying speed greater than the third conveying speed.

23. The method of singulating according to claim 22, further comprising singulating a disorganized flow of articles into the first plurality of articles in the first stream and the second plurality of articles in the second stream.

24. The method of singulating according to claim 21, further comprising providing a plurality of pushers, said pushing including selectively pushing the articles with at least one of said pushers.

25. The method of singulating according to claim 24, wherein said pushing includes selectively pushing one of the articles with a plurality of said pushers.

26. The method of singulating according to claim 24, wherein said selectively pushing said article with a plurality of pushers includes selectively pushing the article with a plurality of contiguous pushers.

27. The method of singulating according to claim 22, wherein said selectively pushing one of the articles from the first stream and from the second stream is based on a desired merge order.

28. The method of singulating according to claim 27, wherein said selecting one of the articles from the first stream and the second stream includes selecting one of the articles from the first stream and second stream based on at least one parameter chosen from an article's size and an article's location.
